(19) United States
(12) Patent Application Publication
(10) Pub. No.: US 2023/0049645 A1
(43) Pub. Date: Feb. 16, 2023

(54) DUST SHEET FOR REDUCING BRAKE NOISE AND BRAKE SYSTEM COMPRISING A DUST SHEET

(71) Applicant: MANDO CORPORATION, Pyeongtaek-si (KR)

(72) Inventor: Hatem SHAHIN, Pfaffenhofen (DE)

(73) Assignee: MANDO CORPORATION, Pyeongtaek-si (KR)

(21) Appl. No.: 17/866,956

(22) Filed: Jul. 18, 2022

(30) Foreign Application Priority Data
Aug. 10, 2021 (DE) 10 2021 208 734.5

(51) Int. Cl. F16D 65/00; B32B 3/26; B32B 5/00; B32B 7/12; B32B 27/00; B32B 5/20

(52) U.S. Cl. CPC F16D 65/0006; F16D 65/0031; B32B 3/26; B32B 5/00; B32B 7/12; B32B 27/00; B32B 5/20; F16D 2250/0069; F16D 2200/0034; F16D 2250/0076; B32B 2255/10; B32B 2255/02; B32B 2307/102; B32B 2307/724; B32B 2307/732; B32B 2307/306; B32B 2307/546; B32B 2605/00; B32B 37/12

(57) ABSTRACT

The invention relates to a dust sheet for a vehicle brake configured for reducing brake noise, to a disk brake system comprising a dust sheet and to a method for making a dust sheet, wherein the dust sheet comprises, at least in a section, two or more layers.

### TECHNICAL FIELD

The application is in the field of mechanical engineering, in particular automotive engineering. It relates to a dust sheet for a vehicle brake which is configured for reducing brake noise and to a brake system comprising such a dust sheet.

### BACKGROUND ART

Reduction of brake noise has long been the subject of research and development, and known approaches for reducing noise include for instance improved brake pad design, wherein novel materials are employed, or chamfers are provided on the brake pads.

Ever more expensive solutions have however not produced fully satisfactory results and it is thus an object of the present invention to present a solution for further reducing brake noise in an inexpensive and effective manner.

### SUMMARY

This is achieved by a dust sheet according to independent claim 1. It is also achieved by a brake system according to claim 18 or a method according to claim 19.

Accordingly, a dust sheet for a vehicle brake is configured for reducing brake noise, wherein the dust sheet comprises, at least in a section, two or more layers.

The two or more layers represent a functional arrangement for attenuating airborne sound emerging from the vehicle brake. The layers may be tuned and configured to optimize damping, as will be explained here below. In particular, the number of layers and/or their material(s) and/or their distance from another and/or their thicknesses may be tuned for efficient damping.

Dust sheets are known brake components, which are supposed to shield further brake parts from dust, small stones or other foreign bodies. The inventor realized that known solutions for reducing brake noise focus on reducing vibrations or structure-borne sound. In a complete turn away from these approaches, the inventor realized that a reduction of airborne sound represents an effective alternative or addition to known approaches, which has been neglected.

The dust sheet may for instance have a total of two or a total of three or a total of four layers, at least in a section.

In the section in which the several layers are arranged, the two or more layers may be arranged plane-parallel to each other. The two or more layers may define a sheet-like extension of the dust sheet.

In embodiments of the dust sheet, at least two adjacent layers of the two or more layers may be arranged at a distance from each other to form one or more cavities between those layers. For instance, a width of at least one of these cavities may be at least 0.1 mm or at least 0.2 mm and/or at most 0.5 mm or at most 0.3 mm.

In embodiments of the dust sheet, one or more webs may extend within at least one of the one or more cavities. The webs may be arranged to connect the two adjacent layers. The webs may improve damping behaviour and/or stability of the dust sheet.

In an embodiment, the dust sheet may comprise at least two webs having a different size from each other. In particular, the at least two webs of different size may be arranged within the same cavity, i.e. connecting the same pair of adjacent layers.

In an embodiment, the dust sheet may comprise at least two webs having a different material from each other. In particular, the at least two webs of different material may be arranged within the same cavity, i.e. connecting the same pair of adjacent layers.

In some embodiments, the webs may have a regular or irregular cross-section. Their cross section may for instance be elliptical or polygonal. In some embodiments, the webs may be elongated and they may for instance extend horizontally or vertically. The webs may be arranged regularly or irregularly. The one or more webs may also be designed and arranged in such a way that they divide the cavity in which they are arranged into several sections, in particular sections of different sizes.

For example, at least one cavity of the one or more cavities may be filled with a filling material. The filling material may for instance be a solid material or a foam or a gel or a powder.

In possible embodiments of the dust sheet, at least two adjacent layers of the two or more layers may be in surface contact with each other. In particular, they may be at least in part or entirely in surface contact with each other.

A thickness of at least one of the two or more layers may be at least 0.2 mm or at least 0.4 mm or at least 0.5 mm and/or at most 1.2 mm or at most 1 mm. In particular, it may be envisioned that the dust sheet comprises a total of two or a total of three or a total of four layers, each of the layers having a thickness as indicated above.

The two or more layers may include at least two layers with a different thickness from each other.

In embodiments, at least one of the two or more layers may comprise or consists of one or more of:
a temperature resistant plastic,
a temperature resistant matrix material, in particular a textile-like matrix material.

In embodiments, the dust sheet may be devoid of metal.

The two or more layers may include at least two layers that are made of a different material from each other.

It may be envisioned that all layers are made of a rigid material. It may also be envisioned that at least one layer is a soft layer. For instance, at least one layer of the two or more layers may be made from a material that is flexible and/or soft and/or designed as a textile-like fabric or web. Damping may advantageously be increased by including such a layer.

In some embodiments, the at least one layer that is made from a material that is flexible and/or soft and/or de-signed as a textile-like fabric or web may be in surface contact with a further layer of the two or more layers that is adjacent to it. In particular it may be glued thereto. It is also possible to arrange the layer that is made from a material that is flexible and/or soft and/or de-signed as a textile-like fabric or web at a distance from its adjacent layer(s).

The at least one layer that is made from a material that is flexible and/or soft and/or designed as a textile-like fabric or web may for instance have a thickness of at least 0.2 mm and/or at most 0.5 mm.

In some embodiments, at least one of the two or more layers may have a coating on at least one side.

In the dust sheet described herein, the section having the two or more layers may be arranged at least in a section of the dust sheet that is configured to face a portion of the brake disk that is opposite to a point of engagement of the brake disk with a brake pad of the brake system. In particular, it is not necessary—though not excluded and also envisioned herein—to extend the dust sheet as a cover over the brake pad and/or caliper. Instead, good results for noise attenuation may advantageously be achieved, if the brake disk is covered opposite from the brake pad.

It will be appreciated by the person of skill, that the aforementioned aspects regarding arrangement with respect to the brake disk may be seen from the dust sheet itself.

A disk brake system according to the invention comprises a dust sheet as described herein. In the brake system, the dust sheet may be configured in such a way that its eigenfrequencies are different from eigenfrequencies of neighbouring brake components, in particular from eigenfrequencies of the brake disk.

A method according to the invention is a method for making a dust sheet as described herein. The method may comprise additive manufacturing. Additionally or alternatively, the method may comprise joining at least two of the two or more layers. The two or more layers may be joined for instance by welding or by gluing.

The features of the present invention may be combined in an advantageous fashion with further features for reducing brake noise.

### BRIEF DESCRIPTION OF THE DRAWINGS

The invention will be explained further with reference to the figures.

Therein:

FIG. 1a shows a brake system with a dust sheet,

FIGS. 1b-d show cut of the brake system of FIG. 1a, with different configurations for the dust sheet,

FIG. 2a shows a cut through a brake system having a dust sheet with two layers,

FIG. 2b shows a cut through a brake system having a dust sheet with three layers,

FIG. 3a shows a dust sheet with two layers,

FIG. 3b shows a dust sheet with three layers,

FIG. 3c shows a dust sheet with two layers and webs in between,

FIGS. 3d, e show dust sheets with two layers of different thickness,

FIG. 3f shows a dust sheet with webs of different sizes,

FIG. 3g shows a dust sheet with two layers of a different material,

FIG. 3h shows a dust sheet with two layers and a filling material disposed in between,

FIG. 3i shows a dust sheet with webs of different materials,

FIGS. 3j-l show dust sheets having a soft layer,

FIGS. 3m-o show dust sheets with a coating, and

FIGS. 3p-s illustrate webs with different cross sections.

### DETAILED DESCRIPTION OF EMBODIMENTS

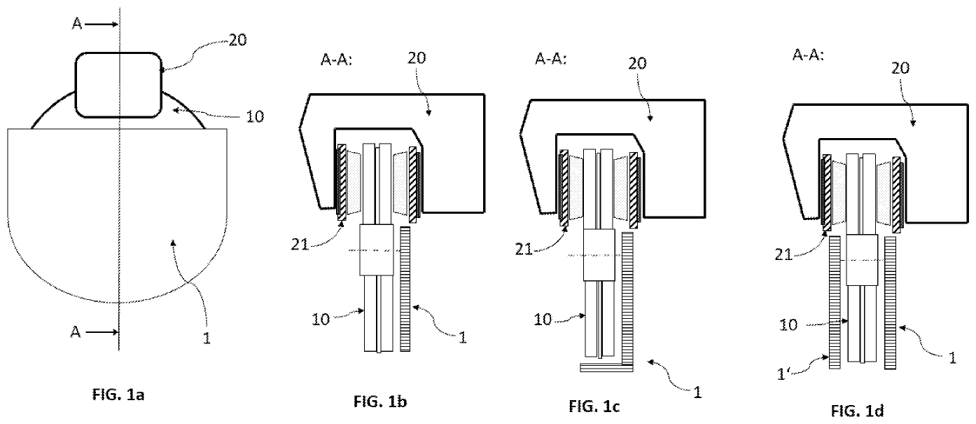

FIG. 1a shows a view onto an inner side of a brake system, a dust sheet 1 is arranged over a substantial portion of a brake disk 10, covering most of the brake disk 10 and preventing dust or stones from entering the brake system and potentially damaging the parts, for instance when they get caught between brake pads and the brake disk. According to the present invention, the dust sheet 1 is configured for reducing brake noise, wherein the dust sheet 1 comprises, at least in a section, two or more layers, as will be explained further here below.

In FIG. 1a, a caliper 20 can be seen, which holds brake pads (see FIGS. 1b-d). In FIG. 1a, a cut A-A is indicated.

FIGS. 1b-d show the cut view of FIG. 1a, exposing the brake pads 21 that are held by the caliper 20. FIGS. 1b-d show different dust sheet configurations. The dust sheets 1, 1′ of FIGS. 1a-1d are, in each case, dust sheets according to the invention, comprising, at least in a section, two or more layers, as will be explained further here below. The dust sheet 1, 1′ is in each case arranged to cover at least a portion of the brake disk 10 that is opposite to a point of engagement of the brake pads 21 with the brake disk 10. By providing the dust sheet 1, 1′ in such a manner, and, specifically, by having the two or more layers opposite to the point of engagement of the brake pads 21 with the brake disk 10, efficient damping of airborne sound can be achieved.

FIG. 1b shows the cut view of FIG. 1a, wherein a first dust sheet configuration is shown. The dust sheet 1 is arranged on an inner side of the brake disk 10.

FIG. 1c shows the cut view of FIG. 1a, wherein a second dust sheet configuration is shown. The dust sheet 1 is arranged on an inner side of the brake disk 10 and encloses the brake disk 10 on the bottom.

FIG. 1d shows the cut view of FIG. 1a, wherein a third dust sheet configuration is shown. The dust sheet 1 is arranged on an inner side of the brake disk 10 and a further dust sheet 1′ is arranged on an outer side of the brake disk 10.

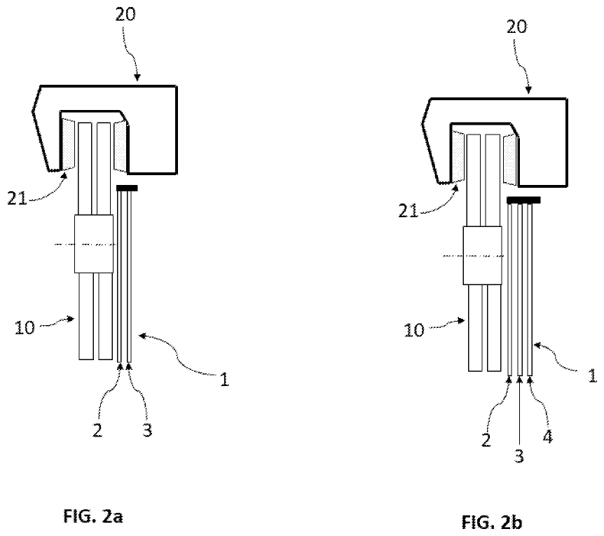

FIGS. 2a and 2b show brake systems, wherein the dust sheet 1 is shown in greater detail. In each case, two or more layers of the dust sheet are visible.

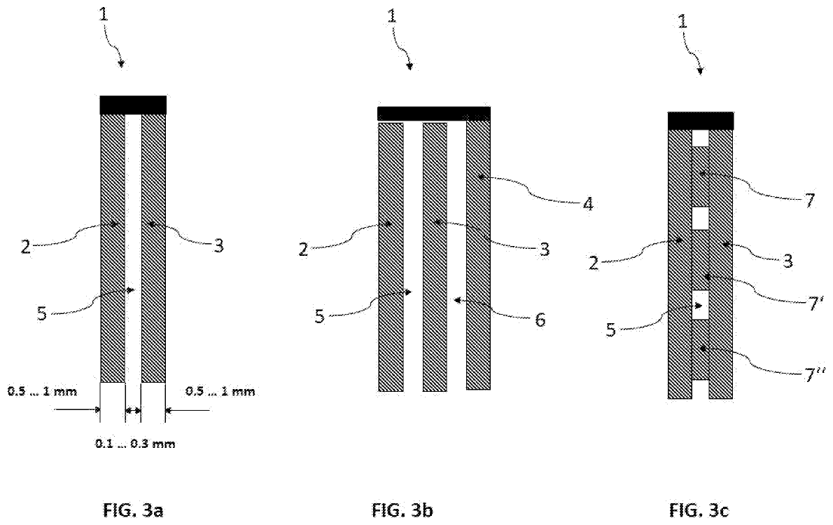

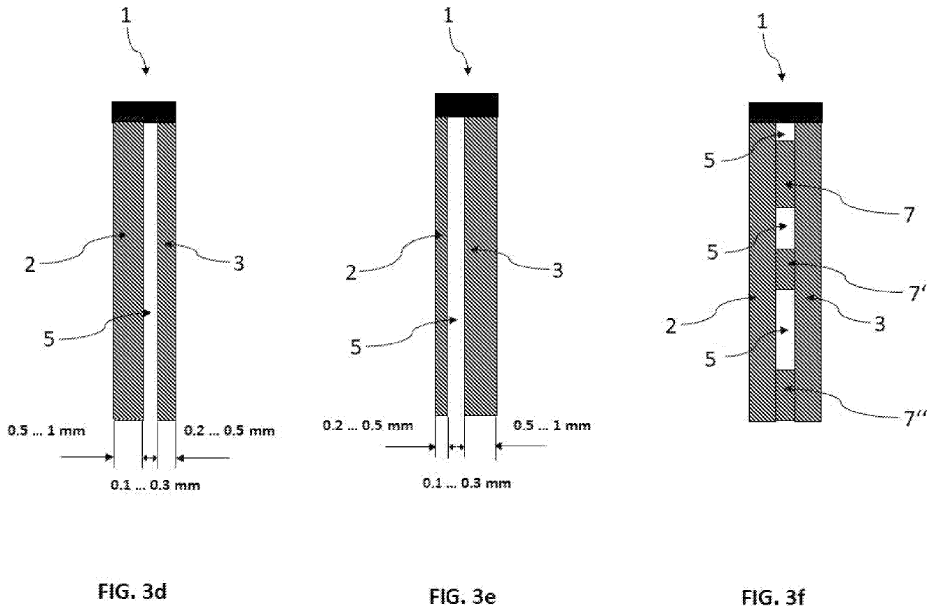

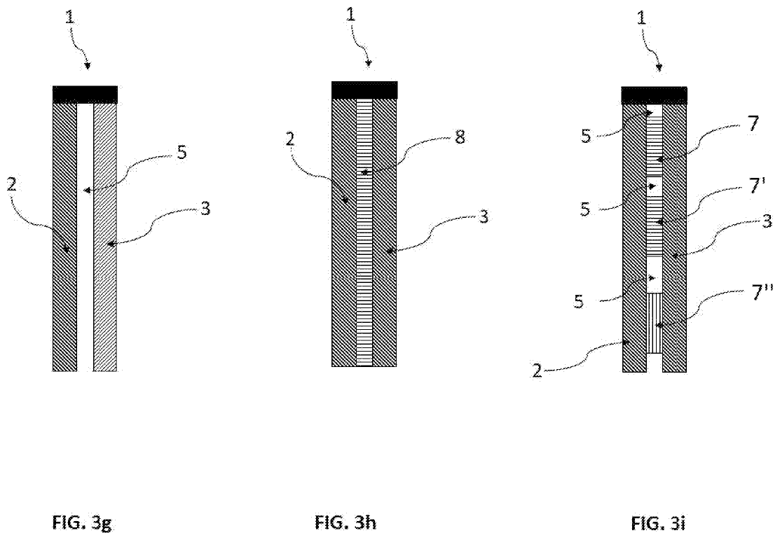

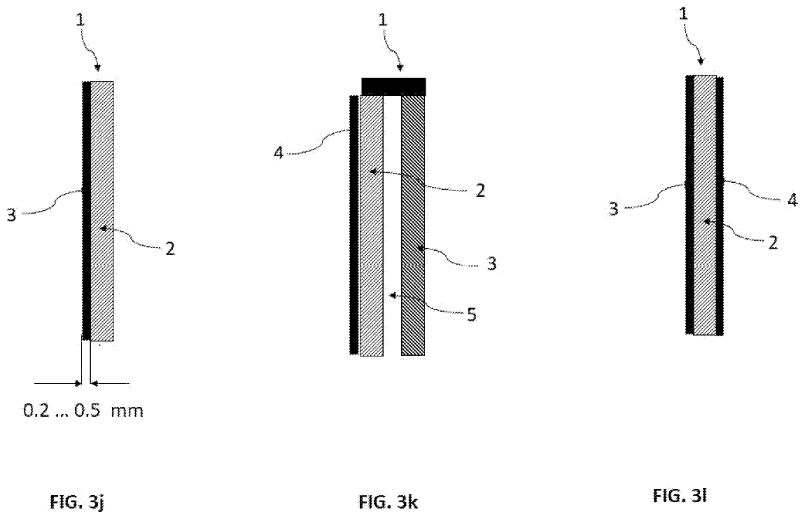

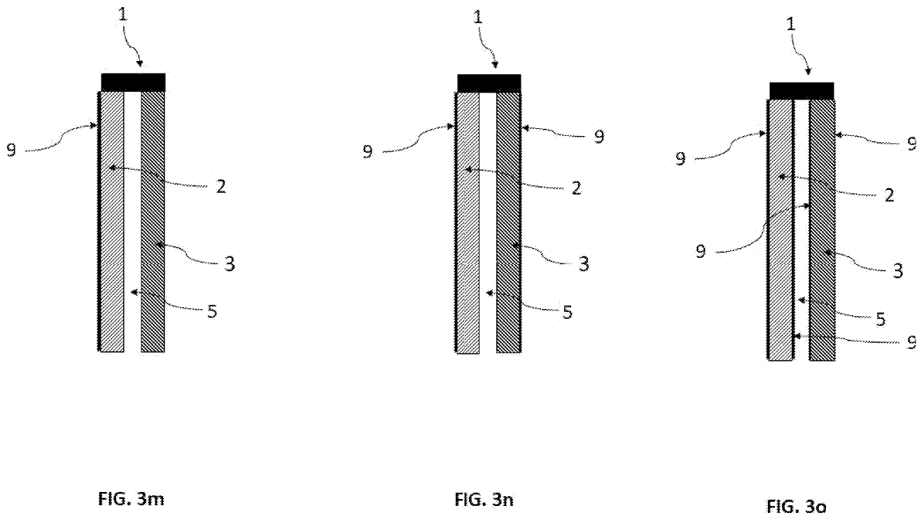

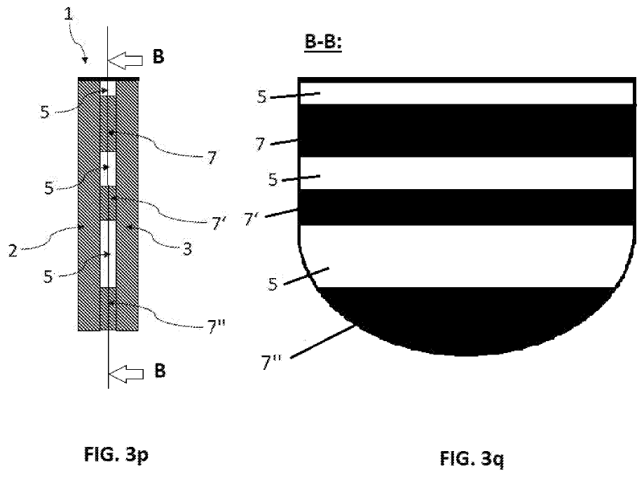

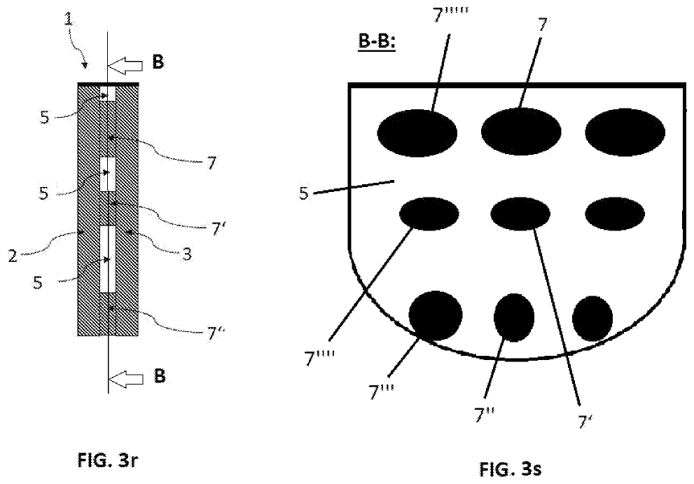

FIG. 2a shows an exemplary embodiment of the dust sheet 1, wherein the dust sheet 1 has two layers 2, 3. FIG. 3b shows an exemplary embodiment of the dust sheet 1, wherein the dust sheet 1 has three layers 2, 3, 4. Dust sheets with two or three layers may be provided for each of the configurations of FIGS. 1a-d.

In the cases of FIGS. 2a and 2b, the layers 2, 3, 4 comprise or consist of one or more of a temperature resistant plastic and a temperature resistant matrix material, in particular a textile-like matrix material. The dust sheets 1 are devoid of metal. The dust sheets 1 are made by additive manufacturing and/or by joining at least two of the two or more layers 2, 3, 4 by welding or gluing.

The dust sheets 1 of FIGS. 2a and 2b are configured in such a way that their eigenfrequencies are different from eigenfrequencies of neighbouring brake components, in particular from eigenfrequencies of the brake disk 10. Tuning of the eigenfrequencies is done, inter alia, by choosing among the various design options shown in FIGS. 3a3s and described below.

FIG. 3a shows the dust 1 sheet configured for reducing brake noise, wherein the dust sheet 1 comprises two layers 2, 3, the two layers 2, 3 being arranged at a distance from each other to form a cavity 5 between them. A width of the cavity is between 0.1 mm and 0.3 mm. A width of each of the layers 2, 3 is between 0.5 mm and 1 mm, the two layers 2, 3 having an equal width.

FIG. 3b shows the dust sheet 1 for reducing brake noise, wherein the dust sheet 1 comprises three layers 2, 3, 4, adjacent layers being arranged at a distance from each other two form, in each case, a cavity 5, 6 between them. A width of each of the cavities 5, 6 is between 0.1 mm and 0.3 mm. A width of each of the layers 2, 3, 4 is between 0.5 mm and 1 mm, the three layers 2, 3 having an equal width.

FIG. 3c shows the dust sheet 1, wherein two layers 2, 3 are arranged at a distance from each other to form the cavity 5, wherein several webs 7, 7′, 7″ extend within the cavity 5, the webs 7, 7′, 7″ connecting the two adjacent layers 2, 3. It is understood that in the case of three layers, as shown in FIG. 3b, webs may be arranged between each pair of adjacent layers, or between only one pair of adjacent layers.

FIG. 3d shows the dust sheet 1, wherein two layers 2, 3 are provided. The layer 2 shown on the left in FIG. 3d is configured to face the brake disk 10. The layer 3 shown on the right in FIG. 3d is configured to face away from the brake disk 10. The layers 2, 3 have a different thickness from each other. The layer 2 on the left has a thickness between 0.5 mm and 1 mm and the layer 3 on the right has a thickness between 0.2 mm and 0.5 mm. The layer 2 facing the brake disk 10 is thicker than the layer 3 facing away from the brake disk 10. The cavity 5 between the layers 2, 3 has a width of between 0.1 mm and 0.3 mm. It is understood that in the case of three layers, as shown in FIG. 3b, the three layers may have different thicknesses from each other.

FIG. 3e shows the dust sheet 1, wherein two layers 2, 3 are provided. The layers 2, 3 have a different thickness from each other. The layer 2 on the left has a thickness between 0.2 mm and 0.5 mm and the layer 3 on the right has a thickness between 0.5 mm and 1 mm. The layer 2 facing the brake disk 10 is thinner than the layer 3 facing away from the brake disk 10. The cavity 5 between the layers 2, 3 has a width of between 0.1 mm and 0.3 mm.

FIG. 3f shows the dust sheet 1, wherein webs 7, 7′, 7″ are provided between the layers 2, 3, each of the webs 7, 7′, 7″ connecting the two layers 2, 3. The webs 7, 7′, 7″ have a different size from each other.

FIG. 3g shows the dust sheet 1 with two layers 2, 3. The layers 2, 3 have different materials from each other. Each of the layers 2, 3 comprises or consists of one or more of a temperature resistant plastic and a temperature resistant matrix material, in particular a textile-like matrix material. It is understood that in the case of three layers, as shown in FIG. 3b, the three layers may have different materials from each other.

FIG. 3h shows the dust sheet, wherein a filling material 8 is provided between the two layers 2, 3. The filling material 8 is a solid material or a foam or a gel or a powder. It is understood that in the case of three layers, as shown in FIG. 3b, filling materials may be provided between each pair of adjacent layers, or between only one pair of adjacent layers.

FIG. 3i shows the dust sheet 1, wherein webs 7, 7′, 7″ are provided between the layers 2, 3, each of the webs 7, 7′, 7″ connecting the two layers 2, 3. The webs 7, 7′, 7″ have different materials from each other.

FIG. 3j shows the dust sheet 1 with two layers 2, 3. The two layers 2, 3 are in surface contact with each other. The layer 3 depicted on the left, configured for facing the brake disk 10, is a thin cover layer that is made from a material that is flexible and/or soft and/or designed as a textile-like fabric or web. The thin cover layer has a thickness of between 0.2 mm and 0.5 mm. The thin cover layer is glued to the layer 2 depicted on the right. The latter layer 2 has a thickness of between 0.5 mm and 1 mm and comprises or consists of one or more of a temperature resistant plastic and a temperature resistant matrix material, in particular a textile-like matrix material.

FIG. 3k shows a further embodiment of the dust sheet with a thin cover layer that is made from a material that is flexible and/or soft and/or designed as a textile-like fabric or web. The dust sheet comprises two layers 2, 3 that may be designed for instance according to any of the embodiments shown in FIG. 3a or 3c-i. Furthermore, the dust sheet comprises a third layer 4 that constitutes the thin cover layer. Said thin cover layer is glued to the layer 2 and is configured for facing the brake disk.

FIG. 3l shows the dust sheet 1, wherein a first layer 2 is arranged at the center and two further layers 3, 4 are glued to the left and right side of the first layer 2, respectively. Both further layers 3, 4 are thin cover layers that are made from materials that are flexible and/or soft and/or designed as a textile-like fabric or web. The further layers 3, 4 have in each case a thickness of at least 0.2 mm and/or at most 0.5 mm. The first layer 2 has a thickness of between 0.5 mm and 1 mm.

FIGS. 3m-o show dust sheets 1 with at least one coating 9. In each case, the dust sheet 1 comprises two layers 2, 3 that may be designed for instance according to any of the embodiments shown in FIG. 3a or 3c-i.

FIG. 3m shows that the coating 9 is arranged to face the brake disk 10.

FIG. 3n shows that coatings 9 are arranged on opposing sides of the dust sheet 1, facing the brake disk 10 and facing away from the brake disk 10.

FIG. 3o shows that coatings 9 are arranged on both sides of each of the layers 2, 3.

FIG. 3p-s show different ways of carrying out the webs. FIG. 3p shows a cut through the dust sheet 1, exposing the two layers 2, 3 and the cavity 5 between the two layers 2, 3. The webs 7, 7″, 7″ extend within the cavity 5 and connect the layers 2, 3, as can also be seen in FIG. 3p. FIG. 3q shows the cut B-B indicated in FIG. 3p. As can be seen from FIG. 3q, the webs 7, 7′, 7″ divide the cavity 5 into several sections of different sizes.

FIG. 3r shows the same cut as in the case of FIG. 3p. Again, the webs 7, 7′, 7″ extend within the cavity 5 and connect the layers 2, 3. As can be seen from cut view B-B shown in FIG. 3s, the webs 7,7″, 7′″, 7″″, 7″″′ are spatially confined features having an elliptical cross-section. Different cross sections may be envisioned, such as polygonal cross sections.

### LIST OF REFERENCE NUMERALS

1, 1′ Dust Sheet
2 First Layer
3 Second Layer
4 Third Layer
5 Cavity
6 Further Cavity
7, 7′, 7″ Web
8, 8′ Filling Material
9 Coating
10 Brake Disk
20 Caliper
21 Brake Pad

What is claimed is:

1. A dust sheet for a vehicle brake, configured for reducing brake noise, wherein the dust sheet comprises, at least in a section, two or more layers.

2. The dust sheet according to claim 1, wherein at least two adjacent layers of the two or more layers are arranged at a distance from each other to form one or more cavities.

3. The dust sheet according to claim 2, wherein a width of at least one cavity of the one or more cavities is at least 0.1 mm or at least 0.2 mm and/or at most 0.5 mm or at most 0.3 mm.

4. The dust sheet according to claim 2, wherein one or more webs extend within at least one cavity of the one or more cavities, the webs connecting the two adjacent layers.

5. The dust sheet according to claim 4, wherein the dust sheet comprises at least two webs having a different size from each other and/or a different material from each other.

6. The dust sheet according to claim 4, wherein the one or more webs are arranged in such a way that they divide the cavity in which they are arranged into several sections, in particular sections of different sizes.

7. The dust sheet according to claim 2, wherein at least one cavity of the one or more cavities is filled with a filling material, in particular with a solid material or a foam or a gel or a powder.

8. The dust sheet according to claim 1, wherein at least two adjacent layers of the two or more layers are in surface contact with each other.

9. The dust sheet according to claim 1, wherein a thickness of at least one of the two or more layers is at least 0.2 mm or at least 0.4 mm or at least 0.5 mm and/or at most 1.2 mm or at most 1 mm.

10. The dust sheet according to claim 1, wherein the two or more layers include at least two layers with a different thickness from each other.

11. The dust sheet according to claim 1, wherein at least one of the two or more layers comprises or consists of one or more of:
a temperature resistant plastic,
a temperature resistant matrix material, in particular a textile-like matrix material.

12. The dust sheet according to claim 1, wherein the dust sheet is devoid of metal.

13. The dust sheet according to claim 1, wherein the two or more layers include at least two layers that are made of a different material from each other.

14. The dust sheet according to claim 1, wherein at least one layer of the two or more layers is made from a material that is flexible and/or soft and/or designed as a textile-like fabric or web.

15. The dust sheet according to claim 14, wherein the at least one layer that is made from a material that is flexible and/or soft and/or de-signed as a textile-like fabric or web is in surface contact with a further layer of the two or more layers, in particular glued thereto.

16. The dust sheet according to claim 14, wherein the at least one layer that is made from a material that is flexible and/or soft and/or de-signed as a textile-like fabric or web has a thickness of at least 0.2 mm and/or at most 0.5 mm.

17. The dust sheet according to claim 1, wherein at least one of the two or more layers has a coating on at least one side.

18. A disk brake system comprising a dust sheet according to claim 1, wherein the dust sheet is configured in such a way that its eigenfrequencies are different from eigenfrequencies of neighbouring brake components, in particular from eigenfrequencies of the brake disk.

19. Method for making a dust sheet according to claim 1, comprising additive manufacturing and/or joining at least two of the two or more layers, in particular by welding or gluing.
